(19) United States
(12) Patent Application Publication
(10) Pub. No.: US 2017/0345091 A1
(43) Pub. Date: Nov. 30, 2017

(54) METHOD OF PROFILING AN INSTITUTION AND A PROFILING SERVER THEREOF

(71) Applicant: Shivansh TYAGI, Bangalore (IN)

(72) Inventor: Shivansh TYAGI, Bangalore (IN)

(21) Appl. No.: 15/356,128

(22) Filed: Nov. 18, 2016

(30) Foreign Application Priority Data
May 26, 2016 (IN) 201641018059

(51) Int. Cl. G06Q 30/08; G06Q 50/20

(52) U.S. Cl. CPC G06Q 30/08; G06Q 50/2053

(57) ABSTRACT

The present invention relates to a method of profiling an institution and profiling server thereof. The method includes enabling, by the profiling server, creation of at least one representative profile. A representative profile of the at least one representative profile is associated with a representative of one or more representatives of the institution. The method also includes assigning, by the profiling server, one or more data collection tasks to each representative of the one or more representatives to collect data associated with the institution. Each data collection task of the one or more data collection tasks is based on incentive. The incentive dynamically varies with corresponding data. Further, the method includes enabling, by the profiling server, validation of the data by at least one validator associated with the institution. Moreover, the method includes recording, by the profiling server, the data associated with the institution based on validation of the data.

### CROSS-REFERENCE TO RELATED APPLICATIONS

This non-provisional application claims priority to Indian Patent Application No. 201641018059, filed on May 26, 2016, which is incorporated herein by reference in its entirety.

### FIELD OF THE INVENTION

The present invention generally relates to institutions and more particularly to a method of profiling an institution and a profiling server thereof.

### BACKGROUND TO THE INVENTION

Growth of education has advanced due to advent of internet technology. A wide variety of courses and educational institutions are available today. For a student, especially one entering into a pre-graduate or a graduate level, there are a vast number of options to choose from based on different variables. Examples of the different variables include, but are not limited to, course type (part time or full time), institute type, industry domain, course duration, fees, prospects, and the like. Often, students and parents rely on close acquaintances, counsellors, alumni and to some extent on media to arrive at a decision for the education. However, such sources are usually biased and may not be efficient in presenting appropriate courses and the educational institutions to suit needs and capabilities of the student. Moreover, a recent study shows that the students wanting to pursue a degree or professional course look at various other parameters or information rather than giving importance to the educational institutions. Such information is typically not available or is found to be inadequate. The student is hence unable to take a right decision.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An example of a method of profiling an institution includes enabling, by a profiling server, creation of at least one representative profile. A representative profile of the at least one representative profile is associated with a representative of one or more representatives of the institution. The method also includes assigning, by the profiling server, one or more data collection tasks to each representative of the one or more representatives to collect data associated with the institution. Each data collection task of the one or more data collection tasks is based on an incentive. The incentive dynamically varies in accordance with corresponding data. Further, the method includes enabling, by the profiling server, validation of the data by at least one validator associated with the institution. Moreover, the method includes recording, by the profiling server, the data associated with the institution based on validation of the data.

An example of a profiling server for profiling an institution includes a communication interface in electronic communication with at least one user device. The profiling server also includes a memory that stores instructions. The profiling server further includes a processor responsive to the instructions to enable creation of at least one representative profile. A representative profile of the at least one representative profile is associated with a representative of one or more representatives of the institution. The processor is also responsive to the instructions to assign one or more data collection tasks to each representative of the one or more representatives to collect data associated with the institution. Each data collection task of the one or more data collection tasks is based on an incentive. The incentive dynamically varies in accordance with corresponding data. Further, the processor is responsive to the instructions to enable validation of the data by at least one validator associated with the institution. Moreover, the processor is responsive to the instructions to record the data associated with the institution based on validation of the data.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1 is an example representation of an environment, in accordance with an embodiment;

FIG. 2 illustrates an example communication flow between a profiling server, a representative device and a validator device, in accordance with an embodiment;

FIG. 3 illustrates an example flow diagram of a method for profiling an institution, in accordance with an embodiment;

FIG. 4 is an example representation of verification and shortlisting of one or more representatives of an institution, in accordance with an embodiment;

FIG. 5 is an example representation of validating data provided by one or more representatives of an institution, in accordance with an embodiment; and

FIG. 6 illustrates a block diagram of an electronic device, in accordance with one embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

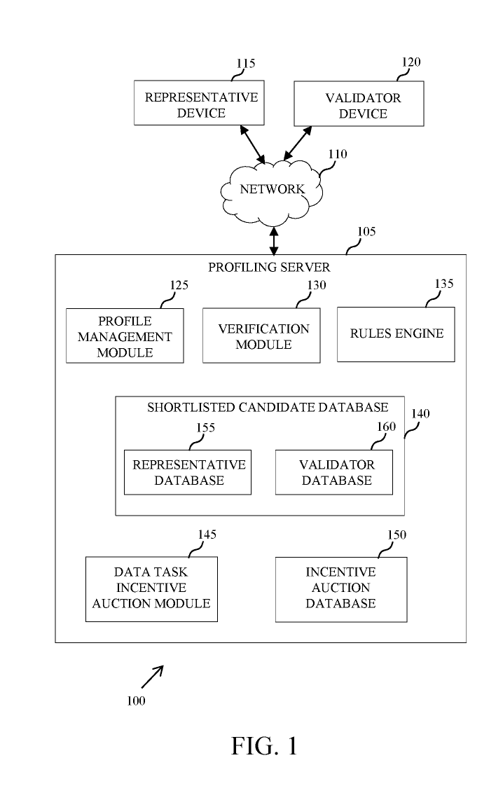

FIG. 1 is an example representation of an environment 100, in accordance with an embodiment. The environment 100 includes a profiling server 105, a network 110, and a plurality of user devices, for example a representative device 115 and a validator device 120. The profiling server 105 communicates with the plurality of user devices, for example the representative device 115 and the validator device 120, through the network 110. FIG. 1 is explained with respect to a single representative device, for example the representative device 115, and a single validator device, for example the validator device 120. However, it should be noted that a plurality of representative devices other than the representative device 115 and a plurality of validator devices other than the validator device 120 can also be similarly included in the environment 100. Examples of the representative device 115 and the validator device 120 include, but are not limited to, a mobile device, a computer, a tablet, a laptop, a palmtop, a handheld device, a telecommunication device, a personal digital assistant (PDA), and the like. Examples of the network 110 includes, but are not limited to, a Local Area Network (LAN), a Wireless Local Area Network (WLAN), a Wide Area Network (WAN), internet, a Small Area Network (SAN), and the like.

The profiling server 105 includes a profile management module 125, a verification module 130, a rules engine 135, a shortlisted candidate database 140, a data task incentive auction module 145, and an incentive auction database 150. The shortlisted candidate database 140 includes a representative database 155 and a validator database 160.

The profile management module 125 enables creation of at least one representative profile. Multiple users or candidates can register with the profiling server 105 by using corresponding devices, for example the representative device 115. A candidate profile is associated with a candidate of the institution. In an educational institution, students and alumni represent the one or more candidates of the educational institution. Each candidate is associated with a representative device, for example the representative device 115. The candidates can register with the profiling server 105 by using the representative device 115 and create candidate profiles. For example, a candidate can create the candidate profile using an application or a website on the representative device 115.

The verification module 130 further verifies the candidate profiles using one or more of college identification or personal identification. The rules engine 135 applies a configurable rule set to the candidate profiles after verification. Based on the configurable rule set, the profiling server 105 evaluates suitability of the candidate profiles by screening a plurality of suitability parameters associated with the candidates and subsequent scoring. Some examples of the suitability parameters include, but are not limited to, seniority level of the candidate (for example, if the candidate is a junior, a senior, an alumni member, and the like), social status of the candidate (for example, how active the candidate is on social networks), and the like.

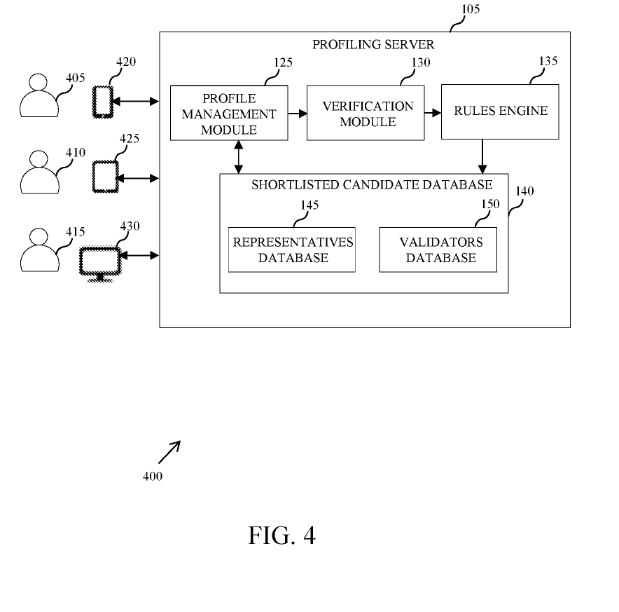

Subsequently, a shortlisted set of candidate profiles are selected from the candidate profiles and are stored in the shortlisted candidate database 140. Based on the scoring of the candidate profiles, top scoring candidate profiles from the shortlisted set of candidate profiles are stored as the representative profiles in the representative database 155. The candidates corresponding to the representative profiles are one or more representatives associated with the institution. Remaining candidate profiles from the shortlisted set of candidate profiles are stored as the validator profiles in the validator database 160. The candidates corresponding to the validator profiles are validators associated with the institution. An example representation of verification and shortlisting of the one or more representatives of the institution is explained with reference to FIG. 4.

The data task incentive auction module 145 assigns one or more data collection tasks to each representative of the one or more representatives to collect data associated with the institution. Examples of the data collection tasks include number of classrooms in the educational institution, types of lab equipment, quality of teaching, activities carried out by the educational institution, and the like. The representative can collect the data corresponding to each data collection task and input the same through the representative device 115, for example using the website or the application.

Each data collection task of the one or more data collection tasks assigned by the data task incentive auction module 145 is based on an incentive. The incentive dynamically varies in accordance with corresponding data. For example, if the data has to be collected immediately, the corresponding data collection task is based on a higher incentive. In another example, if the data is to be collected over a period of time, the incentive for the corresponding data collection task is lesser. In some embodiments, the data collection tasks can be assigned to the representatives of the institution by auctioning the data collection tasks. The incentive auction database 150 stores the data collection tasks that are based on the incentives and are auctioned. The representatives further go ahead and collect the data corresponding to the data collection tasks assigned. The data task incentive auction module 145 receives the data from the representatives and transfers the same to the validators associated with the institution.

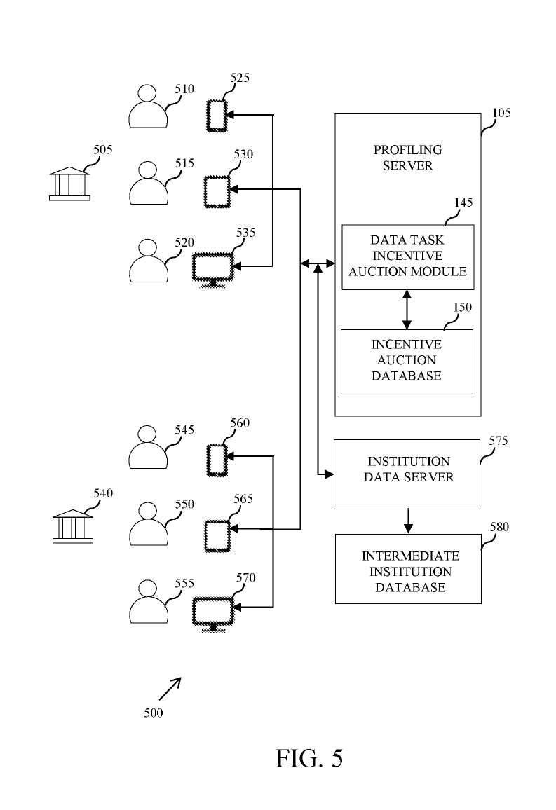

The data is subsequently validated by at least one validator associated with the institution. For example, in the educational institution, faculty members and board members are the validators of the educational institution. Each validator is associated with a validator device, for example the validator device 115. The validator receives the data for validation on the validator device 115 and validates the data. The profiling server 105 further records the data associated with the institution based on validation of the data. The data can be recorded or stored in a database of the profiling server 105. An example representation of validating the data of the one or more representatives of the institution is explained with reference to FIG. 5.

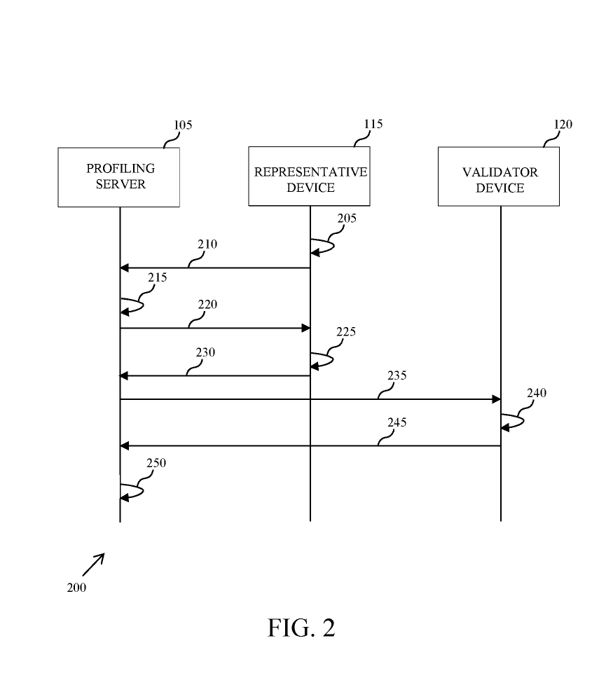

An example embodiment of a communication flow for profiling the institution is explained with reference to FIG. 2.

Referring now to FIG. 2, an example communication flow 200 is illustrated between the profiling server 105, the representative device 115 and the validator device 120, in accordance with an embodiment. The profiling server 105 provides an interface or platform for profiling the institution. In an example, the interface or the platform is a mobile application. In another example, the interface is a website. At step 205, the representative device 115 allows the representative (a candidate) of the institution to access the interface on the representative device 115 and create the representative profile thereby registering with the profiling server 105. The representative profile is associated with the representative of the institution and can include details, for example name, photo, educational details, and the like. At step 210, the profiling server 105 receives the representative profile (or the candidate profile) of the representative from the representative device 115.

At step 215, the profiling server 105 verifies the representative profile and evaluates suitability of the representative profile by screening a plurality of suitability parameters associated with the representative. Some examples of the suitability parameters include, but are not limited to, seniority level of the representative, social status of the representative, and the like.

At step 220, the profiling server 105 assigns one or more data collection tasks to the representative device 115 of the representative to collect data associated with the institution. At step 225, the representative device 115 of the representative can be used by the representative to input the data collected.

At step 230, the profiling server 105 receives the data from the representative device 115. At step 235, the profiling server 105 assigns one or more data validation tasks to the validator device 120 of the validator associated with the institution.

At step 240, the validator device 115 of the validator receives the one or more data validation tasks for validation and the validator validates the data. At step 245, the validator device 120 transfers a data validation report to the profiling server 105. At step 250, the profiling server 105 records the data and the data validation report associated with the institution. The data and the data validation report can be recorded or stored in a database of the profiling server 105.

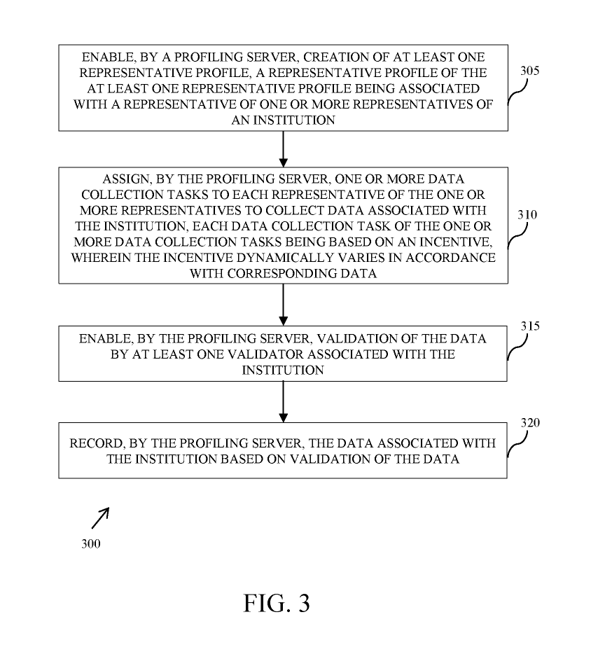

The above steps are explained with respect to a single representative device, for example the representative device 115, and a single validator device, for example the validator device 120. However, it should be noted that the profiling server 105 can be coupled to other representative devices and validator devices to perform the above steps. An example method for profiling the institution is explained with reference to FIG. 3.

FIG. 3 illustrates an example flow diagram of a method 300 for profiling an institution, in accordance with an embodiment. At step 305, the method 300 includes enabling, by a profiling server, for example the profiling server 105 of FIG. 1, creation of at least one representative profile. A representative profile is associated with a representative of one or more representatives of the institution. The creation of the representative profile can include registration of one or more candidates of the institution.

In some embodiments, the creation of the at least one representative profile further includes verifying one or more candidate profiles of the one or more candidates of the institution, by the profiling server. Further, suitability of the one or more candidate profiles can be evaluated by screening a plurality of suitability parameters associated with the one or more candidates. A shortlisted set of candidate profiles is selected from the one or more candidate profiles. The shortlisted set of candidate profiles are scored and based on scoring are classified into the at least one representative profile and at least one validator profile. The representative profile is hence created for the representative using a representative device, for example the representative device 115 of FIG. 1. The method of enabling creation of the at least one representative profile is explained with reference to FIG. 1 and is not explained herein for sake of brevity.

At step 310, the method 300 includes assigning, by the profiling server, one or more data collection tasks to each representative of the one or more representatives to collect data associated with the institution. Each data collection task is based on an incentive which varies dynamically in accordance with corresponding data. For example, a higher incentive is offered for a data collection task that is to be done immediately.

In some embodiments, the data collection tasks are assigned by auctioning the one or more data collection tasks to the one or more representatives. The method of assigning one or more data collection tasks to each representative is explained with reference to FIG. 1 and is not explained herein for sake of brevity.

At step 315, the method 300 includes enabling, by the profiling server, validation of the data by at least one validator associated with the institution. The data that is collected by the representative is sent to the profiling server through the representative device. Based on the data, one or more data validation tasks are assigned to the at least one validator associated with the institution to validate the data. Each data validation task is based on the incentive which dynamically varies in accordance with the corresponding data. Data validation reports are generated by the validators and sent to the profiling server from the validator device, for example the validator device 120 of FIG. 1.

At step 320, the method 300 includes recording, by the profiling server, the data and the data validation reports associated with the institution. The data after validation by the validators is recorded or stored in a database of the profiling server.

Referring now to FIG. 4, an example representation 400 of verification and shortlisting of the one or more representatives of the institution is illustrated, in accordance with an embodiment. The example representation 400 includes a candidate 405, a candidate 410, a candidate 415, a mobile phone 420, a tablet 425, a desktop 430, and the profiling server 105.

Each candidate (for example the candidate 405, the candidate 410, or the candidate 415) of the institution can be associated with one or more representative devices (for example, the mobile phone 420, the tablet 425, and the desktop 430). Each candidate can register with the profiling server 105 (for example, by using an application or a website on the representative devices) and create a candidate profile through at least one of the representative devices. The candidate profiles are uploaded to the profiling server 105 and managed by the profile management module 125.

The candidate profiles are transferred to the verification module 130 that verifies the candidate profiles of the candidates (405 to 415) using one or more of college identification or personal identification. The rules engine 135 applies a configurable rule set to the candidate profiles after verification. Based on the configurable rule set, the profiling server 105 evaluates suitability of the candidate profiles of the candidates (405 to 415) by screening a plurality of suitability parameters associated with the candidates. The candidates (405 to 415) can be scored based on the suitability parameters. For instance, if the candidate 405 is a senior student, is active on social networks, and the like, the candidate profile of the candidate 405 is given a higher score as compared to those of the candidate 410 and the candidate 415.

If scores of the candidates are acceptable, the profiling server 105 accepts the candidate profiles as shortlisted candidate profiles and stores the shortlisted candidate profiles in the shortlisted candidate database 140. As the candidate profile of the candidate 405 is given the higher score as compared to those of the candidate 410 and the candidate 415, the candidate 405 is a representative and the candidate profile of the candidate 405 is stored in the representative database 155. Based on scores associated with the candidate 410 and the candidate 415, it is determined if corresponding candidate profiles are to be stored in the representative database 155 or the validator database 160. The shortlisted candidate database 140 further transmits the representative profiles and the validator profiles to the profile management module 125.

Referring now to FIG. 5, an example representation 500 of validating the data of the one or more representatives of the institution is illustrated, in accordance with an embodiment. The example representation 500 includes an institution 505, a representative 510, a representative 515, a representative 520, a mobile phone 525, a tablet 530, a desktop 535, an institution 540, a representative 545, a representative 550, a representative 555, a mobile phone 560, a tablet 565, a desktop 570, the profiling server 105, an institution data server 575, and an intermediate institution database 580.

Each representative (for example the representative 510, the representative 515, or the representative 520) of the institution 505 can be associated with a representative device (for example, the mobile phone 525, the tablet 530, and the desktop 535), respectively. Each representative (for example the representative 545, the representative 550, or the representative 555) of the institution 540 can be associated with a representative device (for example, the mobile phone 560, the tablet 565, and the desktop 570), respectively.

Each representative can be assigned data collection tasks using auction by the data task incentive auction module 145. Each data collection task can be associated with an incentive, as explained with reference to FIG. 1. The data collection tasks are stored in the incentive auction database 150. The representatives (510 to 520 and 545 to 555) collect data associated with the institution (505 or 540, respectively) as per the data collection tasks assigned. If the institution 505 or the institution 540 is an educational institution, examples of the data collection tasks include number of classrooms in the educational institution, types of lab equipment, quality of teaching, activities carried out by the educational institution, and the like. The representatives (510 to 520 and 545 to 555) can input the data through the representative devices (525 to 535 and 560 to 570) using, for example, the website or the application. The data task incentive auction module 145 receives the data from the representatives of each institution (505 and 540) and transfers the data to the institution data server 575. In an example, a statistical acceptance hypothesis method can be applied to the data. The incentives are further distributed to the representatives (510 to 520 and 545 to 555) after the validation of the data. The data that is validated is further stored in the intermediate institution database 580.

The validators associated with the institution (505 or 540) are further assigned data validation tasks by the data task incentive auction module 145. Each data validation task can be associated with an incentive. The data validation tasks are stored in the incentive auction database 150. The validators validate the data associated with the institution (505 or 540, respectively) as per the data validation tasks assigned. The validators can input data validation reports through respective validator devices using, for example, the website or the application. The institution data server 575 receives the data validation reports from the validators of each institution (505 and 540) and determines accuracy of the data validation reports. The accuracy of the data validation reports is also provided to the data task incentive auction module 145. The incentives are further distributed to the validators after the validation of the data validation reports. The data validation reports that is validated is further stored in the intermediate institution database 580.

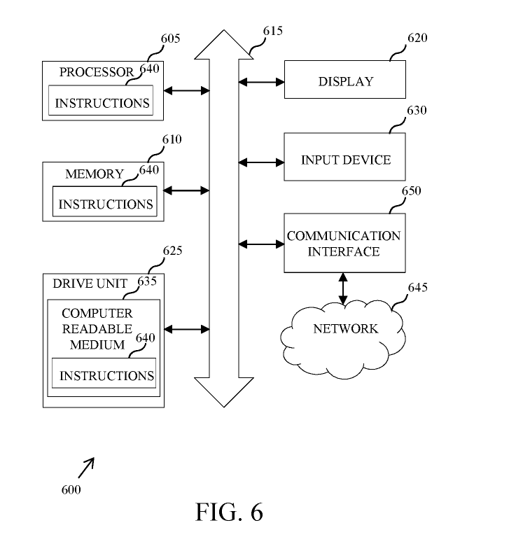

Referring to FIG. 6, a block diagram of an electronic device 600 is illustrated, which is representative of a hardware environment for practicing the present invention. The electronic device 600 can include a set of instructions that can be executed to cause the electronic device 600 to perform any one or more of the methods disclosed. The electronic device 600 may operate as a standalone device or can be connected, for example using a network, to other electronic devices or peripheral devices.

In a networked deployment of the present invention, the electronic device 600 may operate in the capacity of a profiling server, for example the profiling server 105, a representative device, for example the representative device 115 of FIG. 1, or as a validator device, for example the validator device 120 of FIG. 1, in a server-client user network environment, or as a peer electronic device in a peer-to-peer (or distributed) network environment. The electronic device 600 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 600 is illustrated, the term “device” shall also be taken to include any collection of systems or sub-systems that individually or jointly execute a set, or multiple sets, of instructions to perform one or more computer functions.

The electronic device 600 can include a processor 605, for example a central processing unit (CPU), a graphics processing unit (GPU), or both. The processor 605 can be a component in a variety of systems. For example, the processor 605 can be part of a standard personal computer or a workstation. The processor 605 can be one or more general processors, digital signal processors, application specific integrated circuits, field programmable gate arrays, servers, networks, digital circuits, analog circuits, combinations thereof, or other now known or later developed devices for analyzing and processing data. The processor 605 can implement a software program, such as code generated manually (for example, programmed).

The electronic device 600 can include a memory 610, such as a memory 610 that can communicate via a bus 615. The memory 610 can include a main memory, a static memory, or a dynamic memory. The memory 610 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 610 includes a cache or random access memory for the processor 605. In alternative examples, the memory 610 is separate from the processor 605, such as a cache memory of a processor, the system memory, or other memory. The memory 610 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 610 is operable to store instructions executable by the processor 605. The functions, acts or tasks illustrated in the figures or described can be performed by the programmed processor 605 executing the instructions stored in the memory 610. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 600 can further include a display unit 620, for example a liquid crystal display (LCD), an organic light emitting diode (OLED), a flat panel display, a solid state display, a cathode ray tube (CRT), a projector, a printer or other now known or later developed display device for outputting determined information. The display 620 can act as an interface for a user to see the functioning of the processor 605, or specifically as an interface with the software stored in the memory 610 or in a drive unit 625.

Additionally, the electronic device 600 can include an input device 630 configured to allow the user to interact with any of the components of the electronic device 600. The input device 630 can include a stylus, a number pad, a keyboard, or a cursor control device, for example a mouse, or a joystick, touch screen display, remote control or any other device operative to interact with the electronic device 600.

The electronic device 600 can also include the drive unit 625. The drive unit 625 can include a computer-readable medium 635 in which one or more sets of instructions 640, for example software, can be embedded. Further, the instructions 640 can embody one or more of the methods or logic as described. In a particular example, the instructions 640 can reside completely, or at least partially, within the memory 610 or within the processor 605 during execution by the electronic device 600. The memory 610 and the processor 605 can also include computer-readable media as discussed above.

The present invention contemplates a computer-readable medium that includes instructions 640 or receives and executes the instructions 640 responsive to a propagated signal so that a device connected to a network 645 can communicate voice, video, audio, images or any other data over the network 645. Further, the instructions 645 can be transmitted or received over the network 645 via a communication port or communication interface 650 or using the bus 615. The communication interface 650 can be a part of the processor 605 or can be a separate component. The communication interface 650 can be created in software or can be a physical connection in hardware. The communication interface 650 can be configured to connect with the network 645, external media, the display 620, or any other components in the electronic device 600 or combinations thereof. The connection with the network 645 can be a physical connection, such as a wired Ethernet connection or can be established wirelessly as discussed later. Likewise, the additional connections with other components of the electronic device 600 can be physical connections or can be established wirelessly. The network 645 can alternatively be directly connected to the bus 615.

The network 645 can include wired networks, wireless networks, Ethernet AVB networks, or combinations thereof. The wireless network can include a cellular telephone network, an 802.11, 802.16, 802.20, 802.1Q or WiMax network. Further, the network 645 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 600.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

Various embodiments disclosed herein provide numerous advantages by providing a method for profiling an institution and a profiling system thereof. The present invention enables easy and verified data collection for institutions, for example educational institutions, by collecting and validating data by representatives and validators associated with the institutions.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A method of profiling an institution, the method comprising:
enabling, by a profiling server, creation of at least one representative profile, a representative profile of the at least one representative profile being associated with a representative of one or more representatives of the institution;
assigning, by the profiling server, one or more data collection tasks to each representative of the one or more representatives to collect data associated with the institution, each data collection task of the one or more data collection tasks being based on an incentive, wherein the incentive dynamically varies in accordance with corresponding data;
enabling, by the profiling server, validation of the data by at least one validator associated with the institution; and
recording, by the profiling server, the data associated with the institution based on validation of the data.

2. The method as claimed in claim 1, wherein enabling the creation of the at least one representative profile comprises registration of one or more candidates of the institution.

3. The method as claimed in claim 2, wherein enabling the creation of the at least one representative profile further comprises:
verifying, by the profiling server, one or more candidate profiles of the one or more candidates of the institution.

4. The method as claimed in claim 3, wherein enabling the creation of the at least one representative profile further comprises:
evaluating, by the profiling server, suitability of the one or more candidate profiles by screening a plurality of suitability parameters associated with the one or more candidates; and
selecting, by the profiling server, a shortlisted set of candidate profiles from the one or more candidate profiles, the shortlisted set of candidate profiles comprising the at least one representative profile and at least one validator profile.

5. The method as claimed in claim 4, wherein assigning the one or more data collection tasks comprises:
auctioning, by the profiling server, the one or more data collection tasks to the one or more representatives.

6. The method as claimed in claim 5, wherein the incentive dynamically varies in accordance with corresponding data in real time.

7. The method as claimed in claim 6, wherein enabling the validation of the data comprises:
assigning, by the profiling server, one or more data validation tasks to the at least one validator associated with the institution to validate the data associated with the institution, each data validation task of the one or more data validation tasks being based on the incentive, wherein the incentive dynamically varies in accordance with the corresponding data.

8. A profiling server for profiling an institution, the profiling server comprising:
a communication interface in electronic communication with at least one user device;
a memory that stores instructions; and
a processor responsive to the instructions to:
enable creation of at least one representative profile, a representative profile of the at least one representative profile being associated with a representative of one or more representatives of the institution;
assign one or more data collection tasks to each representative of the one or more representatives to collect data associated with the institution, each data collection task of the one or more data collection tasks being based on an incentive, wherein the incentive dynamically varies in accordance with corresponding data;
enable validation of the data by at least one validator associated with the institution; and
record the data associated with the institution based on validation of the data.

9. The profiling server as claimed in claim 8, wherein the processor is further responsive to the instructions to enable the creation of the at least one representative profile by registration of one or more candidates of the institution.

10. The profiling server as claimed in claim 9, wherein the processor is further responsive to the instructions to enable the creation of the at least one representative profile by verifying one or more candidate profiles of the one or more candidates of the institution.

11. The profiling server as claimed in claim 10, wherein the processor is further responsive to the instructions to enable the creation of the at least one representative profile by
evaluating suitability of the one or more candidate profiles, and wherein the suitability is evaluated by screening a plurality of suitability parameters associated with the one or more candidates; and
selecting a shortlisted set of candidate profiles from the one or more candidate profiles, the shortlisted set of candidate profiles comprising the at least one representative profile and at least one validator profile.

12. The profiling server as claimed in claim 11, wherein the one or more data collection tasks are assigned by auctioning the one or more data collection tasks to the one or more representatives.

13. The profiling server as claimed in claim 12, wherein the processor is further responsive to the instructions to enable the validation of the data by
assigning one or more data validation tasks to the at least one validator associated with the institution to validate the data associated with the institution, each data validation task of the one or more data validation tasks being based on the incentive, wherein the incentive dynamically varies in accordance with the corresponding data.
